(19) United States
(12) Patent Application Publication
(10) Pub. No.: US 2021/0171752 A1
(43) Pub. Date: Jun. 10, 2021

(54) RUBBER COMPOSITION COMPRISING A SPECIFIC CRUMB RUBBER

(71) Applicant: COMPAGNIE GENERALE DES ETABLISSEMENTS MICHELIN, Clermont-Ferrand (FR)

(72) Inventor: ETIENNE FLEURY, Clermont-Ferrand (FR)

(21) Appl. No.: 17/254,634

(22) PCT Filed: Jun. 13, 2019
(86) PCT No.: PCT/FR2019/051423

§ 371 Date: Dec. 21, 2020

(30) Foreign Application Priority Data
Jun. 21, 2018 (FR) 1855493

(51) Int. Cl. C08L 23/22; B60C 9/04; C08L 9/06; C08L 7/00; C08K 3/36

(52) U.S. Cl. CPC C08L 23/22; B60C 9/04; C08L 9/06; C08K 3/04; C08K 3/36; B60C 2009/0475; C08L 7/00

(57) ABSTRACT

A rubber composition is based on at least one elastomer, a reinforcing filler, a crosslinking system and from 5 to 100 phr of a crumb rubber, the crumb having a mean size D50 of between 100 and 300 μm, and a particle size distribution such that the ratio of the mean sizes D10/D50 is greater than or equal to 0.5; the composition also comprises 1 to 10 phr of a tackifying resin having a number-average molecular weight (Mn) greater than 800 g/mol and a polydispersity index (PI) greater than or equal to 2.0.

The invention relates to compositions, in particular for tyres, and more especially to compositions comprising a crumb rubber.

Indeed, it is at the current time advantageous for tyre manufacturers to find solutions to minimizing the environmental impact of rubber compositions without penalizing the performance of the tyres using these compositions.

It is known in the prior art that crumb rubbers can be used in tyres. For example, document US 2014/0228505 describes the use of a crumb rubber with a size of less than 60 mesh (250 μm) in compositions for tyres.

However, the simple reduction in the size of the crumbs can generate reduced performance in terms of green tack, especially during the manufacture of tyres, in particular when they are present in large amounts.

The applicant has now shown that a composition comprising a particular crumb rubber constitutes an efficient recycling of vulcanized rubber materials, making it possible to obtain rubber compositions having a reduced environmental impact, and very good green tack, allowing facilitated industrial use, in particular for the manufacture of tyres.

The invention therefore relates to a rubber composition based on at least one elastomer, a reinforcing filler, a crosslinking system and from 5 to 100 phr of a crumb rubber, said crumb having a mean size D50 of between 100 and 300 μm, and a particle size distribution such that the ratio of the mean sizes D10/D50 is greater than or equal to 0.5; said composition also comprising 1 to 10 phr of a tackifying resin having a number-average molecular weight (Mn) greater than 800 g/mol and a polydispersity index (PI) greater than or equal to 2.0.

The invention also relates to a tyre comprising a composition as defined above, preferably in all or part of its tread.

The tyre according to the invention will preferentially be selected from tyres intended to equip a two-wheel vehicle, a passenger vehicle, or else a “heavy-duty” vehicle (that is to say, underground, bus, off-road vehicles, heavy road transport vehicles, such as lorries, tractors or trailers), or else aircraft, construction equipment, heavy agricultural vehicles or handling vehicles.

### I—Constituents of the Composition

The rubber compositions according to the invention are based on at least one elastomer, a reinforcing filler, a crosslinking system and from 5 to 100 phr of a crumb rubber, said crumb having a mean size D50 of between 100 and 300 μm, and a particle size distribution such that the ratio of the mean sizes D10/D50 is greater than or equal to 0.5; said composition also comprising 1 to 10 phr of a tackifying resin having a number-average molecular weight (Mn) greater than 800 g/mol and a polydispersity index (PI) greater than or equal to 2.0.

The expression “composition based on” should be understood as meaning a composition including the mixture and/or the product of the in situ reaction of the various base constituents used, some of these constituents being able to react and/or being intended to react with each other, at least partially, during the various phases of manufacture of the composition or during the subsequent curing, modifying the composition as it is prepared at the start. Thus, the compositions as employed for the invention can be different in the non-crosslinked state and in the crosslinked state.

Moreover, for the purposes of the present patent application, the term “phr” means part by weight per hundred parts of elastomers, within the meaning of the preparation of the composition before curing. That is to say, in the case of the presence of a crumb rubber, that the term “phr” means part by weight per hundred parts of “new” elastomers, thus excluding from the base 100 the elastomers contained in the crumb rubber.

In the present description, unless expressly indicated otherwise, all the percentages (%) shown are mass percentages. Furthermore, any interval of values denoted by the expression “between a and b” represents the range of values extending from more than “a” to less than “b” (i.e. limits a and b excluded), while any interval of values denoted by the expression “from a to b” means the range of values extending from “a” up to “b” (i.e. including the strict limits a and b).

When reference is made to a “predominant” compound, this is understood to mean, for the purposes of the present invention, that this compound is predominant among the compounds of the same type in the composition, that is to say that it is the one which represents the greatest amount by weight among the compounds of the same type and in particular more than 50%, preferably more than 75%. Thus, for example, a predominant polymer is the polymer representing the greatest weight, with respect to the total weight of the polymers in the composition. In the same way, a “predominant” filler is that representing the greatest weight among the fillers of the composition. By way of example, in a system comprising just one polymer, the latter is predominant for the purposes of the present invention and, in a system comprising two polymers, the predominant polymer represents more than half of the weight of the polymers. On the contrary, a “minor” compound is a compound which does not represent the greatest mass fraction among the compounds of the same type.

For the purposes of the present invention, when reference is made to a “predominant” unit (or monomer) within one and the same compound (or polymer), this is understood to mean that this unit (or monomer) is predominant among the units (or monomers) forming the compound (or polymer), that is to say that it is the one which represents the greatest fraction by weight among the units (or monomers) forming the compound (or polymer).

The compounds mentioned in the description can be of fossil origin or be biobased. In the latter case, they can result, partially or completely, from biomass or be obtained from renewable starting materials resulting from biomass. Polymers, plasticizers, fillers, and the like, are concerned in particular.

### I-1 Elastomer

The elastomer can be selected from the group consisting of diene elastomers and mixtures thereof.

It should be remembered here that elastomer (or “rubber”, the two terms being regarded as synonymous) of the “diene” type should be understood, in a known way, to mean an elastomer resulting at least in part (i.e., a homopolymer or a copolymer) from diene monomers (monomers bearing two conjugated or non-conjugated carbon-carbon double bonds).

Diene elastomers can be classified in two categories: “essentially unsaturated” or “essentially saturated”. “Essentially unsaturated” is generally understood to mean a diene elastomer resulting at least in part from conjugated diene monomers having a content of units of diene origin (conjugated dienes) which is greater than 15% (mol %); thus it is that diene elastomers such as butyl rubbers or copolymers of dienes and of α-olefins of EPDM type do not come within the preceding definition and can in particular be described as “essentially saturated” diene elastomers (low or very low content, always less than 15%, of units of diene origin). In the category of “essentially unsaturated” diene elastomers, a “highly unsaturated” diene elastomer in particular refers to a diene elastomer having a content of units of diene origin (conjugated dienes) which is greater than 50%.

Given these definitions, a diene elastomer capable of being used in the compositions according to the invention is understood more particularly to mean:

(a) any homopolymer obtained by polymerization of a conjugated diene monomer containing from 4 to 12 carbon atoms;
(b) any copolymer obtained by copolymerization of one or more conjugated dienes with each other or with one or more vinylaromatic compounds containing from 8 to 20 carbon atoms;
(c) a ternary copolymer obtained by copolymerization of ethylene and of an α-olefin containing from 3 to 6 carbon atoms with a non-conjugated diene monomer containing from 6 to 12 carbon atoms, for instance the elastomers obtained from ethylene and propylene with a non-conjugated diene monomer of the abovementioned type notably such as 1,4-hexadiene, ethylidenenorbornene or dicyclopentadiene;
(d) a copolymer of isobutene and of isoprene (butyl rubber) and also the halogenated versions, in particular chlorinated or brominated versions, of this type of copolymer.

Although it applies to any type of diene elastomer, those skilled in the art of tyres will understand that the present invention is preferably employed with essentially unsaturated diene elastomers, in particular of the above type (a) or (b).

The following are suitable in particular as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene, 2-methyl-3-isopropyl-1,3-butadiene, aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The copolymers may contain between 99% and 20% by weight of diene units and between 1% and 80% by weight of vinylaromatic units. The elastomers may have any microstructure, which depends on the polymerization conditions used, notably on the presence or absence of a modifying and/or randomizing agent and on the amounts of modifying and/or randomizing agent used. The elastomers can, for example, be block, random, sequential or microsequential elastomers and can be prepared in dispersion or in solution; they can be coupled and/or star-branched or else functionalized by a coupling and/or star-branching or functionalization agent. The term “functional group” is preferably understood here to mean a chemical group which interacts with the reinforcing filler of the composition.

Preferably, the elastomer of the composition predominantly comprises an essentially unsaturated diene elastomer. The elastomer of the composition is preferably selected from the group consisting of polybutadienes (abbreviated to BRs), synthetic polyisoprenes (IRs) or natural polyisoprenes (NRs), butadiene copolymers, isoprene copolymers and mixtures of these elastomers. Such butadiene and isoprene copolymers are more preferentially, respectively, butadiene/styrene copolymers (SBRs) and isoprene/styrene copolymers (SIRs).

More preferentially, the predominant elastomer is selected from the group consisting of polybutadienes (BR), butadiene-styrene (SBR) copolymers, natural (NR) or synthetic (IR) polyisoprenes and mixtures of these elastomers.

### I-2 Reinforcing Filler

The composition according to the invention comprises a reinforcing filler. Use may be made of any type of reinforcing filler known for its abilities to reinforce a rubber composition which can be used for the manufacture of tyres, for example an organic filler, such as carbon black, a reinforcing inorganic filler, such as silica or alumina, or else a blend of these two types of filler.

Preferably, the content of reinforcing filler is within a range extending from 5 to 200 phr, preferably from 20 to 160 phr.

For the requirements of the invention, the reinforcing filler is preferably selected from the group consisting of silicas, carbon blacks and mixtures thereof. More preferably, the reinforcing filler is predominantly carbon black, preferably at a content within a range extending from 30 to 90 phr. Likewise preferentially, the reinforcing filler is predominantly silica, preferably in a content within a range extending from 30 to 90 phr.

All carbon blacks, notably “tyre-grade” blacks, are suitable as carbon blacks. Among the latter, mention will be made more particularly of the reinforcing carbon blacks of the 100, 200 or 300 series (ASTM grades), for instance the N115, N134, N234, N326, N330, N339, N347 or N375 blacks, or else, depending on the applications targeted, blacks of higher series (for example N660, N683 or N772). The carbon blacks might, for example, be already incorporated in an isoprene elastomer in the form of a masterbatch (see, for example, Applications WO 97/36724 and WO 99/16600).

Mention may be made, as examples of organic fillers other than carbon blacks, of functionalized polyvinyl organic fillers, such as described in Applications WO-A-2006/069792, WO-A-2006/069793, WO-A-2008/003434 and WO-A-2008/003435.

The composition can comprise one type of silica or a blend of several silicas. The silica used may be any reinforcing silica known to those skilled in the art, especially any precipitated or fumed silica with a BET surface area and a CTAB specific surface area that are both less than 450 m²/g, preferably from 30 to 400 m²/g. Mention will be made, as highly dispersible precipitated silicas (“HDSs”), for example, of the Ultrasil 7000 and Ultrasil 7005 silicas from the company Evonik, the Zeosil 1165MP, 1135MP and 1115MP silicas from the company Solvay, the Hi-Sil EZ150G silica from the company PPG, the Zeopol 8715, 8745 and 8755 silicas from the company Huber, treated precipitated silicas, such as, for example, the silicas “doped” with aluminium described in Application EP-A-0735088, or the silicas with a high specific surface area as described in Application WO 03/16387. The silica preferably has a BET specific surface of between 45 and 400 m²/g, more preferably of between 60 and 300 m²/g.

These compositions can optionally also comprise, in addition to the coupling agents, coupling activators, agents for covering the inorganic fillers or more generally processing aids capable, in a known way, by virtue of an improvement in the dispersion of the filler in the rubber matrix and of a lowering of the viscosity of the compositions, of improving their ability to be processed in the raw state, these agents being, for example, hydrolysable silanes, such as alkylalkoxysilanes, polyols, fatty acids, polyethers, primary, secondary or tertiary amines, or hydroxylated or hydrolysable polyorganosiloxanes.

Those skilled in the art will understand that use might be made, as filler equivalent to silica described in the present section, of a reinforcing filler of another nature, in particular organic nature, provided that this reinforcing filler is covered with a layer of silica or else comprises, at its surface, functional sites, in particular hydroxyl sites, requiring the use of a coupling agent in order to establish the bond between the filler and the elastomer.

The physical state under which the reinforcing filler is provided is not important, whether in the form of a powder, of micropearls, of granules, of beads or any other appropriate densified form.

### I-3 Crosslinking System

In the composition of the invention, use may be made of any type of crosslinking system known to those skilled in the art for rubber compositions.

The crosslinking system is preferably a vulcanization system, that is to say based on sulfur (or on a sulfur-donating agent) and on a primary vulcanization accelerator. Additional to this base vulcanization system are various known secondary vulcanization accelerators or vulcanization activators, such as zinc oxide, stearic acid or equivalent compounds, or guanidine derivatives (in particular diphenylguanidine), incorporated during the first non-productive phase and/or during the productive phase, as are described subsequently.

The sulfur is used at a preferred content of between 0.5 and 10 phr, more preferably of between 0.5 and 5 phr, in particular between 0.5 and 3 phr.

The vulcanization system of the composition according to the invention may also comprise one or more additional accelerators, for example compounds of the family of the thiurams, zinc dithiocarbamate derivatives, sulfenamides, guanidines or thiophosphates. Use may be made in particular of any compound that is capable of acting as accelerator of the vulcanization of diene elastomers in the presence of sulfur, notably accelerators of the thiazole type and derivatives thereof, and accelerators of thiuram or zinc dithiocarbamate type. These accelerators are more preferably selected from the group consisting of 2-mercaptobenzothiazole disulfide (abbreviated to “MBTS”), N-cyclohexyl-2-benzothiazolesulfenamide (abbreviated to “CBS”), N,N-dicyclohexyl-2-benzothiazolesulfenamide (abbreviated to “DCBS”), N-(tert-butyl)-2-benzothiazolesulfenamide (abbreviated to “TBBS”), N-(tert-butyl)-2-benzothiazolesulfenimide (abbreviated to “TBSI”), zinc dibenzyldithiocarbamate (abbreviated to “ZBEC”) and mixtures of these compounds. Preferably, use is made of a primary accelerator of the sulfenamide type.

### I-4 Crumb Rubber

The composition of the invention also comprises from 5 to 100 phr of a crumb rubber (abbreviated to “crumb” in the remainder of the text).

The crumbs are presented in the form of granules, optionally put into the form of a rubber plaque. Generally, crumb rubbers result from a grinding or from a micronization of cured rubber compositions already used for a first application, for example in tyres; they are a product of the recycling of materials. The crumbs thus preferably consist of a composition based on at least one elastomer and a filler. The crumbs are preferably provided in the form of microparticles.

The term “microparticles” is intended to mean particles which have a size, namely their diameter in the case of spherical particles or their largest dimension in the case of anisometric particles, of a few tens of or a few hundred microns.

For the purposes of the invention, the crumb rubber has a mean size D50 of between 100 and 300 μm, and a particle size distribution such that the ratio of the mean sizes D10/D50 is greater than or equal to 0.5, preferably between 0.55 and 0.95 and more preferentially between 0.6 and 0.9, and even more preferentially between 0.65 and 0.85.

These specific crumbs can be obtained by various technologies, in particular by cryogenic micronization processes as described in documents U.S. Pat. Nos. 7,445,170 and 7,861,958. According to another embodiment of the invention, the crumbs can be obtained by other micronization processes known to those skilled in the art and not limited to the cryogenic process alone.

Depending on the size distribution of objects obtained, the crumb obtained by the cited processes can undergo an additional sieving step so as to control this distribution. The sieving can be carried out by various technologies (vibration, centrifugation, suction) known to those skilled in the art.

Likewise, commercially available crumbs such as the “PD80” crumb from Lehigh Technologies can be used.

Preferably, the crumb is present at a content within a range extending from 5% to 40% by weight, preferably from 10% to 30% and more preferably from 15% to 25%. In a typical composition intended for the tyre, these contents by weight correspond to contents of 5 to 100 phr. Below 5 phr, the saving made would not be significant enough, whereas, above 100 phr, it is possible for the cohesion properties of the composition to be penalized. Thus, the crumb content is preferably within a range extending from 10 to 90 phr, preferentially from 15 to 90 phr, more preferentially from 20 to 80 phr and very preferentially from 30 to 70 phr for optimum operation of the invention.

As discussed above, the crumbs preferably consist of a composition based on an elastomer and a filler. They may also comprise all the ingredients normally used in rubber compositions, such as plasticizers, antioxidants, vulcanization additives, etc.

Thus, the crumb comprises an elastomer, preferentially a diene elastomer. This elastomer preferentially represents at least 30% by weight, more preferentially at least 35% by weight, even more preferentially at least 45% by weight of the weight of the crumb, said percentage being determined according to standard ASTM E1131. It is preferentially selected from the group consisting of polybutadienes, polyisoprenes including natural rubber, butadiene copolymers and isoprene copolymers. More preferably, the molar content of units of diene origin (conjugated dienes) present in the diene elastomer is greater than 50%, preferably between 50% and 70%.

According to a preferred embodiment of the invention, the crumb contains between 5% and 80% by weight of filler, more preferably between 10% and 75% and very preferably between 15% and 70%.

The term “filler” is understood here to mean any type of filler, whether it is reinforcing (typically having nanometric particles, preferably with a weight-average size of less than 500 nm, in particular between 20 and 200 nm) or whether it is non-reinforcing or inert (typically having micrometric particles, preferably with a weight-average size of greater than 1 μm, for example between 2 and 200 μm). The weight-average size of the nanometric particles is measured in a manner well known to those skilled in the art (by way of example, according to patent application WO 2009/083160 paragraph I.1). The weight-average size of the micrometric particles can be determined by mechanical screening.

Mention will in particular be made, as examples of fillers known as reinforcing to those skilled in the art, of carbon black or of a reinforcing inorganic filler, such as silica or alumina in the presence of a coupling agent, or mixtures thereof.

According to a preferred embodiment of the invention, the crumb comprises, by way of filler, a reinforcing filler, in particular a carbon black or a mixture of carbon blacks.

The carbon black or the mixture of carbon blacks preferentially represents more than 50%, more preferentially more than 80%, even more preferentially more than 90% by weight of the weight of the reinforcing filler of the crumb. According to a more preferential embodiment, the reinforcing filler consists of a carbon black or a mixture of carbon blacks.

Very preferably, the carbon black is present in the crumb at a content ranging from 20% to 40% by weight, more preferably from 25% to 35% by weight.

All carbon blacks, in particular blacks of the HAF, ISAF, SAF, FF, FEF, GPF and SRF type, conventionally used in rubber compositions for tyres (“tyre-grade” blacks) are suitable as carbon blacks.

The crumb can contain all the other usual additives which participate in a rubber composition, in particular for a tyre. Among these usual additives, mention may be made of liquid or solid plasticizers, non-reinforcing fillers such as chalk, kaolin, protective agents, vulcanization agents. These additives may be in the crumb in the form both of a residue or of a derivative, since they were able to react during the steps of producing the composition or of crosslinking the composition from which the crumb is derived.

As regards the constituents of the crumb, it is preferable, for the requirements of the invention, for the crumb to exhibit an acetone extract of between 3% and 30% by weight, more preferably within a range extending from 5% to 25% by weight.

It is also preferable for the crumb to exhibit a chloroform extract of between 5% and 85% by weight, more preferably within a range extending from 5% to 50% by weight.

The crumbs can be simple ground/micronized rubber materials, without other treatment. It is also known that these crumbs can undergo a treatment in order to modify them. This treatment can consist of a chemical functionalization or devulcanization modification. It can also be a thermomechanical, thermochemical, biological, and the like, treatment.

For the invention, it is possible to use a crumb which has a morphology modified by heat and/or mechanical, and/or biological and/or chemical treatment. This type of crumb has an acetone extract of between 5% and 20% by weight, more preferentially within a range extending from 10% to 18% by weight. Likewise, these crumbs have a chloroform extract of between 15% and 85% by weight, more preferentially within a range extending from 15% to 50% by weight. Preferably, the chloroform extract of such a crumb rubber has a weight-average molecular weight (Mw) of greater than 10 000 g/mol, preferably of greater than 20 000 g/mol and more preferably of greater than 30 000 g/mol. This type of crumb is such that the ratio of the chloroform extract to the acetone extract, expressed as weight percentage, is greater than or equal to 1.5, preferably greater than 2.

Preferentially for the invention, use is made of a crumb which has not undergone any modification by thermal and/or mechanical and/or biological and/or chemical treatment. Preferentially, this type of crumb has an acetone extract of between 3% and 15% by weight, more preferentially within a range extending from 3% to 10% by weight. Likewise, it is preferable for the crumb to have a chloroform extract of between 3% and 20% by weight, more preferentially within a range extending from 5% to 15% by weight. Preferably, the chloroform extract of the crumb rubber exhibits a weight-average molecular weight (Mw) of less than 10 000 g/mol, preferably of less than 8000 g/mol. Preferably in this type of crumb rubber, the ratio of the chloroform extract to the acetone extract, expressed as weight percentage, is less than 1.5.

### I-5 Specific Hydrocarbon-Based Resin—Tackifying Resin

The composition according to the invention comprises a specific hydrocarbon-based resin, known as tackifying resin. This tackifying resin has a number-average molecular weight (Mn) greater than 800 g/mol and a polydispersity index (PI) greater than or equal to 2.0. The number-average molecular weight (Mn) and the polydispersity index (PI) are measured by the size exclusion chromatography (SEC) technique, according to the methods defined below.

For the purposes of the invention, this tackifying resin is present in a content ranging from 1 to 10 phr, preferentially from 1 to 8 phr, more preferentially from 2 to 7 phr. Below 1 phr, the effect of the resin is not sufficient, while above 10 phr, the resin could modify the stiffness and glass transition temperature properties of the composition.

The tackifying resin preferably has a glass transition temperature Tg within a range extending from −50° C. to 100° C., more preferentially from 40 to 60° C. The Tg is measured according to ASTM D3418 (1999).

Preferably, the tackifying resin has a softening point within a range extending from 0 to 160° C., preferably from 90 to 110° C. The softening point is measured according to standard ISO 4625 (ring and ball method).

Preferably, the tackifying resin has an Mn greater than 1000 g/mol, more preferentially greater than 1200 g/mol.

Preferably, the tackifying resin has a PI greater than 2.0, more preferentially greater than 2.1.

The tackifying resin of use for the purposes of the invention may be selected from natural or synthetic resins. Among the synthetic resins, it may preferentially be selected from thermoplastic hydrocarbon-based resins which are aliphatic or aromatic, or else of the aliphatic/aromatic type, that is to say based on aliphatic and/or aromatic monomers. Suitable as aromatic monomers are, for example: styrene, α-methylstyrene, ortho-, meta- or para-methylstyrene, vinyltoluene, para-(tert-butyl)styrene, methoxystyrenes, chlorostyrenes, vinylmesitylene, divinylbenzene, vinylnaphthalene or any vinylaromatic monomer resulting from a C₉ fraction (or more generally from a C₈ to C₁₀ fraction). Preferably, the vinylaromatic monomer is styrene or a vinylaromatic monomer resulting from a C₉ fraction (or more generally from a C₈ to C₁₀ fraction). Preferably, the vinylaromatic monomer is the minor monomer, expressed as molar fraction, in the copolymer under consideration.

According to a particularly preferential embodiment, the tackifying resin of use for the purposes of the invention is selected from the group consisting of aliphatic hydrocarbon-based resins and mixtures thereof, and especially from resins of homopolymers or copolymers of cyclopentadiene (abbreviated to CPD) or dicyclopentadiene (abbreviated to DCPD), resins of homopolymers or copolymers of a C₅ fraction and mixtures thereof.

### I-6 Other Possible Additives

The rubber compositions in accordance with the invention optionally also comprise all or a portion of the normal additives generally used in elastomer compositions intended in particular for the manufacture of treads, such as, for example, pigments, protective agents, such as antiozone waxes, chemical antiozonants or antioxidants, plasticizing agents (such as oils or plasticizing resins other than the tackifying resins described above), anti-fatigue agents, reinforcing resins, methylene acceptors (for example novolac phenolic resin) or methylene donors (for example HMT or H3M).

Of course, the compositions in accordance with the invention can be used alone or as a blend (i.e., as a mixture) with any other rubber composition which can be used for the manufacture of tyres.

It goes without saying that the invention relates to the rubber compositions described previously both in the “uncured” or non-crosslinked state (i.e., before curing) and in the “cured” or crosslinked, or also vulcanized, state (i.e., after crosslinking or vulcanization).

### II—Preparation of the Rubber Compositions

The compositions are manufactured in appropriate mixers, using two successive phases of preparation which are well known to those skilled in the art: a first phase of thermomechanical working or kneading (sometimes referred to as “non-productive” phase) at high temperature, up to a maximum temperature of between 110° C. and 200° C., preferably between 130° C. and 180° C., followed by a second phase of mechanical working (sometimes referred to as “productive” phase) at lower temperature, typically below 110° C., for example between 60° C. and 100° C., during which finishing phase the crosslinking or vulcanization system is incorporated; such phases have been described, for example, in applications EP-A-0 501 227, EP-A-0 735 088, EP-A-0 810 258, WO00/05300 or WO00/05301.

The first (non-productive) phase is preferentially performed in several thermomechanical steps. During a first step, the elastomers, the reinforcing fillers, the crumbs (and optionally the tackifying resin, the coupling agents and/or other ingredients, with the exception of the crosslinking system) are introduced into an appropriate mixer, such as an ordinary internal mixer, at a temperature of between 20° C. and 100° C. and preferably between 25° C. and 100° C. After a few minutes, preferably from 0.5 to 2 min, and a rise in the temperature to 90° C. to 100° C., the other ingredients (that is to say, those which remain, if not all were put in at the start) are added all at once or portionwise, with the exception of the crosslinking system, during a compounding ranging from 20 seconds to a few minutes. The total duration of the kneading, in this non-productive phase, is preferably between 2 and 10 minutes at a temperature of less than or equal to 180° C. and preferentially of less than or equal to 170° C.

After cooling of the mixture thus obtained, the crosslinking system is then incorporated at low temperature (typically less than 100° C.), generally in an external mixer, such as an open mill; the whole is then mixed (productive phase) for a few minutes, for example between 5 and 15 min.

The final composition thus obtained is subsequently calendered, for example in the form of a sheet or of a plaque, notably for laborator characterization, or else extruded, in order to form, for example, a rubber profile used in the manufacture of semi-finished products for tyres. These products can subsequently be used in the manufacture of tyres, according to techniques known to those skilled in the art, with the advantage of the invention, namely good tack of the layers on one another before curing of the tyre.

The crosslinking (or curing) is performed in a known manner at a temperature generally of between 130° C. and 200° C., under pressure, for a sufficient time which may range, for example, between 5 and 90 min, as a function notably of the curing temperature, of the vulcanization system adopted, of the kinetics of crosslinking of the composition under consideration or else of the size of the tyre.

The examples that follow illustrate the invention without, however, limiting it.

### III—Implementational Examples of the Invention

### III-1 Characterization of the Crumb Rubbers and of the Rubber Compositions of the Examples

In the examples, the crumb rubbers are characterized as indicated below.

### Measurement of the Size of the Crumb Particles:

The crumb particle size weight distribution can be measured by laser particle size analysis, on a mastersizer 3000 device from Malvern. The measurement is carried out by the liquid route, diluted in alcohol after an ultrasound pretreatment for 1 min in order to guarantee the dispersion of the particles. The measurement is carried out in accordance with standard ISO-13320-1 and makes it possible to determine in particular the D10 and the D50, that is to say the mean diameter below which respectively 10% by weight and 50% by weight of the total population of particles are present.

### Measurement of the Fraction by Weight of Carbon Black:

The carbon black weight fraction is measured by thermogravimetric analysis (TGA) according to standard NF T-46-07, on an instrument from the company Mettler Toledo, model “TGA/DSC1”. Approximately 20 g of sample are introduced into the thermal analyser, then subjected to a thermal program from 25 to 600° C. under an inert atmosphere (pyrolysable phase), then from 400 to 750° C. under an oxidizing atmosphere (oxidizable phase). The weight of the sample is measured continuously throughout the thermal program. The organic matter content corresponds to the loss of weight measured during the pyrolysable phase related back to the initial weight of sample. The black content corresponds to the loss of weight measured during the oxidizable phase related back to the initial weight of sample.

### Measurement of the Acetone Extract:

The acetone extract content is measured according to standard ISO1407 by means of an extractor of soxhlet type.

A sample test specimen (between 500 mg and 5 g) is introduced into an extraction chamber and then placed in the extractor tube of the soxhlet. A volume of acetone equal to two or three times the volume of the extractor tube is placed in the collector of the Soxhlet. The Soxhlet is subsequently assembled and then heated for 16 h.

The sample is weighed after extraction. The acetone extract content corresponds to the loss of weight of the sample during the extraction, related back to the initial weight thereof.

It is also possible to calculate the content of elastomer, which corresponds to the content of organic matter determined by thermogravimetric analysis from which the content of acetone extract is subtracted.

### Measurement of the Chloroform Extract:

The chloroform extract content is measured according to standard ISO1407 by means of an extractor of soxhlet type.

A sample test specimen (between 500 mg and 5 g) is introduced into an extraction chamber and then placed in the extractor tube of the soxhlet. A volume of chloroform equal to two or three times the volume of the extractor tube is placed in the collector of the Soxhlet. The Soxhlet is subsequently assembled and then heated for 16 h.

The sample is weighed after extraction. The chloroform extract content corresponds to the loss of weight of the sample during the extraction, related back to the initial weight thereof.

### Measurement of the Average Molecular Weights of the Chloroform Extract:

The molecular weights are determined by size exclusion chromatography, according to a Moore calibration and according to standard ISO16014.

The measurement of the weight-average molecular weight (Mw) of the chloroform extract is carried out by size exclusion chromatography (SEC) with a refractive index (RI) detector. The system is composed of an Alliance 2695 system from Waters, of a column oven from Waters and also of an RI 410 detector from Waters. The set of columns used is composed of two PL GEL MIXED D columns (300×7.5 mm 5 μm) followed by two PL GEL MIXED E columns (300×7.5 mm 3 μm) from the company Agilent. These columns are placed in a column oven thermostatically controlled at 35° C. The mobile phase used is non-antioxidized tetrahydrofuran. The flow rate of the mobile phase is 1 ml/min. The RI detector is also thermostatically controlled at 35° C.

The chloroform extract is dried under a nitrogen stream. The dry extract is subsequently taken up at 1 g/l in non-antioxidized tetrahydrofuran at 250 ppm with stirring for 2 hours. The solution obtained is filtered using a syringe and a single-use 0.45 μm PTFE syringe filter. 100 μl of the filtered solution are injected into the conditioned chromatographic system at 1 ml/min and 35° C.

The Mw results are provided by integration of the chromatographic peaks detected by the RI detector above a value of 2000 g/mol. The Mw is calculated from a calibration carried out using polystyrene standards.

In the examples, the rubber compositions are characterized before curing as indicated below.

Green Tack (or Tack):

Tack is the ability of an assembly of unvulcanized mixtures to withstand a tearing stress.

A test device inspired by the probe tack tester (ASTM D2979-95) is used for measuring the green tack (tack). An Instron tensile testing machine comprising a fixed metal jaw and a mobile metal jaw is used. A first test specimen consisting of a 3 mm thick film of mixture is adhered to the fixed jaw. A second test specimen consisting of a 3 mm thick film of mixture is adhered to the mobile jaw. The films of mixture are adhered to the surface of the metal jaws with a double-sided adhesive (Tesafix® 4970).

In order to prepare the test specimens of mixture, the films of mixture are obtained by calendering to a thickness of 3 mm. The test specimens are cut by means of a punch of 1 cm diameter.

The measurement principle consists of bringing the two films of mixture into contact for 16 seconds while applying a compressive force of 30 N. After this contact phase, they are separated by being driven by the crosshead of the tensile testing machine. The rate of displacement of the crosshead in this tearing phase is 60 mm/s. The displacement of the crosshead and the force are measured continuously as a function of time during the contact and tearing phases.

The green tack result is the measurement of the maximum force (in Newtons, N) reached during tearing. A value of 35 N and above is considered good performance in the context of the present invention.

### Percentage of Recycled Material in the Mixture:

The percentage of recycled material in the mixture is determined taking into account the weight content of crumb rubber relative to the total weight of the mixture comprising the crumb rubber and the other ingredients of the composition. This percentage is 0% in the reference mixture not comprising crumb rubber, and it is calculated as indicated above for each mixture comprising a crumb.

### III-2 Preparation of the Crumbs

Any composition may be suitable for the preparation of these crumbs. For the implementation examples, the crumbs used result from recycling tyres from heavy duty vehicles.

The crumbs used in the examples of compositions below were prepared by cryogenic grinding according to the process described in document U.S. Pat. No. 7,445,170, comprising the successive and independent steps of granulation, of separation of the metal and textile reinforcements, of cooling and of micronization in order to to obtain a coarse distribution of micronic particles of vulcanized mixture. This micronization is carried out using a conical impact mill as described in document U.S. Pat. No. 7,861,958. The cryogenic input enters the mill, then is transferred by gravity to a rotor rotating at high speed. The cryogenized input is thus projected onto the walls of the rotor chamber multiple times leading to its micronization. The particles then pass through a series of two vibrating screens of the same size (20 mesh) in order to separate the last elements not made of vulcanized mixture. A coarse distribution of micronic particles of vulcanized mixture is obtained.

An additional step of separation according to a size criterion was carried out to obtain the other crumbs used in composition in the implementation examples. This separation step is carried out using a series of screens stacked in order of size. Thus, the larger particles are retained on the screen while the smaller ones pass to the lower stage on the next screen. Those skilled in the art will understand that the distributions considered below can be composed of all the particles that pass through a given screen or of all the particles retained between 2 stages.

The size distribution not retained by a 40 mesh screen constitutes “crumb 1” mentioned below.

The size distribution not retained by a 60 mesh screen constitutes “crumb 2” mentioned below.

The size distribution between an 80 mesh screen and a 140 mesh screen constitutes “crumb 3” mentioned below.

The size distributions of the 3 crumbs considered in the composition examples, determined by laser particle size analysis, are shown in table 1 below. This table also presents the composition characteristics of these crumbs.

TABLE 1

| | Crumb 1 | Crumb 2 | Crumb 3 |
|---|---|---|---|
| D 10 | 59 | 52 | 112 |
| D 50 | 161 | 126 | 167 |
| D 90 | 341 | 257 | 249 |
| D 10/D 50 | 0.37 | 0.41 | 0.67 |

| | |
|---|---|
| Organic matter content (%) | 63.2 |
| Acetone extract content (%) | 5.7 |
| Elastomer content (%) | 57.5 |
| Carbon black content (%) | 29.6 |
| Chloroform extract content (%) | 7.5 |
| MW (g/mol) of the chloroform | 7000 |
| extract | |

### III-3 Rubber Compositions

The compositions are manufactured with introduction of all of the constituents into an internal mixer, with the exception of the vulcanization system. The vulcanization agents (sulfur and accelerator) are introduced onto an external mixer at low temperature (the constituent rollers of the mixer being at approximately 30° C.).

The object of the examples presented in table 2 is to compare the various rubber properties of compositions in accordance with the invention (C6 to C9) to the properties of compositions not in accordance with the invention (C0 to C5). The properties are presented in table 3.

TABLE 2

| | C0 | C1 | C2 | C3 | C4 | C5 | C6 | C7 | C8 | C9 |
|---|---|---|---|---|---|---|---|---|---|---|
| NR (1) | 60 | 60 | 60 | 60 | 60 | 60 | 60 | 60 | 60 | 60 |
| BR (2) | 10 | 10 | 10 | 10 | 10 | 10 | 10 | 10 | 10 | 10 |
| SBR (3) | 30 | 30 | 30 | 30 | 30 | 30 | 30 | 30 | 30 | 30 |
| Carbon black (4) | 62 | 62 | 62 | 62 | 62 | 62 | 62 | 62 | 62 | 62 |
| Crumb 1 (5) | 0 | 46 | 0 | 0 | 0 | 0 | 0 | 0 | 0 | 0 |
| Crumb 2 (5) | 0 | 0 | 46 | 46 | 46 | 46 | 0 | 0 | 0 | 0 |
| Crumb 3 (5) | 0 | 0 | 0 | 0 | 0 | 0 | 46 | 46 | 46 | 46 |
| Oil (6) | 10.2 | 10.2 | 10.2 | 10.2 | 10.2 | 10.2 | 10.2 | 10.2 | 10.2 | 10.2 |
| Tack resin (7) | 0 | 0 | 0 | 3 | 6 | 9 | 0 | 3 | 6 | 9 |
| Antioxidant (8) | 1.5 | 1.5 | 1.5 | 1.5 | 1.5 | 1.5 | 1.5 | 1.5 | 1.5 | 1.5 |
| Stearic acid (9) | 2.5 | 2.5 | 2.5 | 2.5 | 2.5 | 2.5 | 2.5 | 2.5 | 2.5 | 2.5 |
| Zinc oxide (10) | 2.5 | 2.5 | 2.5 | 2.5 | 2.5 | 2.5 | 2.5 | 2.5 | 2.5 | 2.5 |
| Accelerator (11) | 0.9 | 0.9 | 0.9 | 0.9 | 0.9 | 0.9 | 0.9 | 0.9 | 0.9 | 0.9 |
| Sulfur | 1.3 | 1.3 | 1.3 | 1.3 | 1.3 | 1.3 | 1.3 | 1.3 | 1.3 | 1.3 |

(1) NR: Natural rubber
(2) BR: polybutadiene, CB24 from Lanxess; 96% of cis-1,4; Tg = −107° C.
(3) SBR with 26.5% by weight of styrene units and 24% of 1,2-units of the butadiene part (Tg = 48° C.)
(4) Carbon black, ASTM N375 grade
(5) Crumbs 1 to 3 as presented in table 1
(6) MES (Medium Extracted Solvates) oil (Catenex SNR from Shell)
(7) Escorez 1102 tackifying resin from EXXON (Mn 1370 g/mol; PI = 2.3)
(8) N-(1,3-Dimethylbutyl)-N′-phenyl-p-phenylenediamine (Santoflex 6-PPD) from Flexsys
(9) Pristerene 4931 stearin from Uniqema
(10) Zinc oxide, industrial grade - Umicore
(11) N-Cyclohexyl-2-benzothiazolesulfenamide (Santocure CBS from Flexsys)

TABLE 3

| | C0 | C1 | C2 | C3 | C4 | C5 | C6 | C7 | C8 | C9 |
|---|---|---|---|---|---|---|---|---|---|---|
| GT (force in N) | 59 | 8 | 6 | 21 | 28 | 34 | 37 | 45 | 58 | 64 |
| % by weight of | 0.0 | 22.1 | 22.1 | 21.8 | 21.5 | 21.2 | 22.1 | 21.8 | 21.5 | 21.2 |
| recycled material | | | | | | | | | | |

It is noted that the compositions comprising a crumb make it possible to integrate into the mixture a large amount of recycled material of approximately 21% to 22%, and therefore to lower the environmental impact. However, it is also noted for the compositions not in accordance with the invention that the green tack (GT) performance is lowered below 35 N, including when adding a tackifying resin. On the other hand, the specific crumb of the invention allows a good green tack, even without tackifying resin, and in the presence of such a resin, makes it possible to achieve a level as efficient as the control, while at the same time having a higher content of recycled material (and therefore a lower environmental impact).

1.-23. (canceled)

24. A rubber composition based on:
at least one elastomer;
a reinforcing filler;
a crosslinking system;
from 5 to 100 phr of a crumb rubber, the crumb having a mean size D50 of between 100 and 300 μm, and a particle size distribution such that a mean size ratio D10/D50 is greater than or equal to 0.5; and
1 to 10 phr of a tackifying resin having a number-average molecular weight Mn greater than 800 g/mol and a polydispersity index PI greater than or equal to 2.0.

25. The rubber composition according to claim 24, wherein the mean size ratio D10/D50 of the crumb rubber is between 0.55 and 0.95.

26. The rubber composition according to claim 24, wherein the crumb rubber is present at a content ranging from 10 to 90 phr.

27. The rubber composition according to claim 24, wherein the crumb rubber has an acetone extract of between 3% and 30% by weight.

28. The rubber composition according to claim 24, wherein the crumb rubber has a chloroform extract of between 5% and 85% by weight.

29. The rubber composition according to claim 24, wherein the crumb rubber has not undergone any modification selected from thermal, mechanical, biological, and chemical treatments.

30. The rubber composition according to claim 29, wherein the crumb rubber as an acetone extract of between 3% and 15% by weight.

31. The rubber composition according to claim 30, wherein the crumb rubber has a chloroform extract of between 3% and 20% by weight.

32. The rubber composition according to claim 31, wherein the crumb rubber has a ratio of the chloroform extract to the acetone extract, expressed as percentage by weight, of less than 1.5.

33. The rubber composition according to claim 29, wherein the crumb rubber has a chloroform extract of which the weight-average molecular weight is less than 10 000 g/mol.

34. The rubber composition according to claim 24, wherein the crumb rubber has a carbon black weight fraction ranging from 20% to 40%.

35. The rubber composition according to claim 24, wherein the at least one elastomer predominantly comprises an elastomer selected from the group consisting of essentially unsaturated diene elastomers.

36. The rubber composition according to claim 35, wherein the predominant elastomer is selected from the group consisting of polybutadienes, polyisoprenes, butadiene copolymers, isoprene copolymers and mixtures thereof.

37. The rubber composition according to claim 36, wherein the predominant elastomer is selected from the group consisting of polybutadienes, butadiene-styrene copolymers, natural or synthetic polyisoprenes and mixtures thereof.

38. The rubber composition according to claim 24, wherein the reinforcing filler is selected from the group consisting of silicas, carbon blacks and mixtures thereof.

39. The rubber composition according to claim 24, wherein the content of tackifying resin is within a range extending from 1 to 8 phr.

40. The rubber composition according to claim 24, wherein the tackifying resin has a number-average molecular weight Mn greater than 1000 g/mol.

41. The rubber composition according to claim 24, wherein the tackifying resin has a polydispersity index PI greater than 2.0.

42. A tire comprising the rubber composition according to claim 24.

43. The tire according to claim 42, wherein a tread of the tire comprises the rubber composition.
